(19) United States
(12) Patent Application Publication
(10) Pub. No.: US 2007/0051428 A1
(43) Pub. Date: Mar. 8, 2007

(54) CHAMFER TOOL

(76) Inventor: Scott J. Sullivan, Dresser, WI (US)

Correspondence Address: QUARLES & BRADY LLP, 411 E. WISCONSIN AVENUE, SUITE 2040, MILWAUKEE, WI, 53202-4497, US

(21) Appl. No.: 11/465,613

(22) Filed: Aug. 18, 2006

Related U.S. Application Data
(60) Provisional application No. 60/711,490, filed on Aug. 26, 2005.

(51) Int. Cl. B27C 5/00

(52) U.S. Cl. 144/136.1

(57) ABSTRACT

A portable chamfer tool includes a housing configured to support a blade to cut a tenon into a workpiece as the housing is rotated about the workpiece. The portable chamfer tool also includes a passage through the housing configured to receive the workpiece and expose the workpiece to at least one blade to form the tenon and at least one sighting hole disposed in the housing to expose a portion of the workpiece as it travels through the passage. The portable chamfer tool further includes a plurality of measuring markers disposed about the at least one sighting hole to indicate a measure of a length of the portion of the workpiece exposed by the at least one sighting hole. Accordingly, the portable chamfer tool provides a means to form a taper on a first end of a peg disposed in a tenon and mortise joint that is substantially matched to a preformed taper on a second end of the peg that was driven through the tenon and mortise joint.

### CROSS-REFERENCE TO RELATED APPLICATION

This application claims the benefit of U.S. Provisional Patent Application No. 60/711,490 filed Aug. 26, 2005, and entitled “Chamfer Tool.”

### STATEMENT REGARDING FEDERALLY SPONSORED RESEARCH OR DEVELOPMENT

Not applicable.

### BACKGROUND OF THE INVENTION

The present invention relates generally to a system and method for chamfering a tenon or peg and, more particularly, to a system and method for accurately controlling a tenon or peg taper length using a portable chamfer tool.

Traditional portable chamfer tools are useful tools in woodworking applications because they enable a user to create a tenon or tapered peg using traditional hand drills rather than a floor standing lathe or similar stationary tool. However, typical tools require the user to rely on estimated tenon or taper lengths and do not provide a means to accurately assess the length of the tenon or taper without ceasing the cutting process and removing the workpiece from the chamfer tool. As a result, these portable chamfer tools have limited applications

For example, timber frame homes built using a traditional construction process are a popular home design option. Referring to FIG. 1, a traditional tenon-and-mortise joint 1 used in the construction of timber homes or buildings is shown. The mortise 3, tenon 2, and peg 4 are typically formed at a preformed and assembled during the job-site construction process. To construct the tenon-and-mortise joint 1, the precut tenon 2 is aligned and positioned in the precut mortise 3 and the preformed pegs 4 are pounded through holes in the tenon-and-mortise joint 1. Typically, the peg 4 is driven through the tenon-and-mortise joint 1 by using a mallet to strike a backside of the peg 4. To aid in driving the peg 4 through the joint 1, the peg 4 typically includes a tapered forward portion 5 and a full diameter backside portion 6. That is, the forward portion 5 of the peg 4 includes a preformed taper configured to aid in driving the peg 4 into the joint 1, while the backside portion 6 is not tapered to present a full striking surface for the builder to hit the mallet against.

Referring now to FIG. 2, a rear elevational view of the joint 1 in assembled form is shown. Once the peg 4 has been driven through the joint 1, the backside portion 6 of the peg 4 that was not driven into the joint 1 is sawed relatively flush with the joint 1. As such, each joint 1 in a timber frame home or building generally has one tapered end 7 and one blunt end 8, which is not particularly aesthetically pleasing to the eventual homeowner or building owner.

Therefore, it would be desirable to have a system and method for accurately controlling the length of a tenon or tapered peg during the cutting process. Furthermore, it would be desirable to have a system and method to taper a blunt end of a peg driven through a mortise-and-tenon joint.

### BRIEF SUMMARY OF THE INVENTION

The present invention overcomes the aforementioned drawbacks by providing a system and method for accurately controlling a tenon or peg taper length using a portable chamfer tool.

In accordance with one aspect of the invention, a portable chamfer tool is disclosed that includes a housing configured to support a blade to cut a tenon in a workpiece as the housing is rotated about the workpiece. The portable chamfer tool also includes a passage through the housing configured to receive the workpiece and expose the workpiece to at least one blade to form the tenon and at least one sighting hole disposed in the housing to expose a portion of the workpiece as it travels through the passage. The portable chamfer tool further includes a plurality of measuring markers disposed about the at least one sighting hole to indicate a measure of a length of the portion of the workpiece exposed by the at least one sighting hole.

In accordance with another aspect of the invention, a method of constructing a tenon and mortise joint is disclosed that includes positioning a precut tenon inside a precut mortise and aligning at least one precut peg hole in the tenon with at least one precut peg hole in the mortise. The method further includes driving a first end of a peg having a preformed taper thereabout into the at least one precut peg hole in the tenon and the at least one precut peg hole in the mortise by striking a second end of the peg having a consistent diameter. Furthermore, the method includes forming a taper on the second end of the peg using a portable chamfer tool once the peg is positioned through the at least one precut peg hole in the tenon and the at least one precut peg hole in the mortise.

In accordance with yet another aspect of the invention, a portable chamfer tool is disclosed that includes a first end configured to receive a workpiece for creating a tenon therein. The portable chamfer tool also includes a first portion configured to be rotated about the workpiece to cut the tenon from the workpiece and a second portion configured to receive the tenon as it passes from the first portion and provide a metered indication of a length of the tenon as it is formed by the first portion.

Various other features and advantages of the present invention will be made apparent from the following detailed description and the drawings.

### BRIEF DESCRIPTION OF THE DRAWINGS

FIG. 1 is a perspective exploded view of a mortise and tenon joint and factory tapered pegs;

FIG. 2 is an assembled rear elevational view of the mortise and tenon joint of FIG. 1;

FIG. 3 is a plan view of a portable chamfer tool having a tenon/peg taper length sight and associated metering marks in accordance with the present invention;

FIG. 4a is an additional plan view of the portable chamfer tool of FIG. 3 having a tenon/peg taper length sight and associated metering marks;

FIG. 4b is side elevational view of the portable chamfer tool of FIGS. 3 and 4a having a tenon/peg taper length sight and associated metering marks;

FIG. 4c is a perspective view of the portable chamfer tool of FIGS. 3-4b having a tenon/peg taper length sight and associated metering marks;

FIG. 4d is a front elevational view of the portable chamfer tool of FIGS. 3-4c having a tenon/peg taper length sight and associated metering marks;

FIG. 5 is a plan view of a portable chamfer tool having a tenon/peg taper length sight and associated metering marks in accordance with the present invention;

FIG. 6a is a perspective view of an angled portable chamfer tool having a tenon/peg taper length sight and associated metering marks and showing a blade mounted in a blade receptacle;

FIG. 6b is a perspective view of the angled portable chamfer tool of FIG. 6a having a tenor/peg taper length sight and associated metering marks;

FIG. 7 is a perspective view of a portable drill interface for a portable chamfer tool having a pin or peg connection system;

FIG. 8 is a perspective view of a portable drill interface for a portable chamfer tool having a threaded connection system; and

FIG. 9 is an assembled rear elevational view of the mortise and tenon joint of FIGS. 1 and 2 including a peg having matched tapered ends created using a portable chamfer tool of the type shown in FIGS. 3-8.

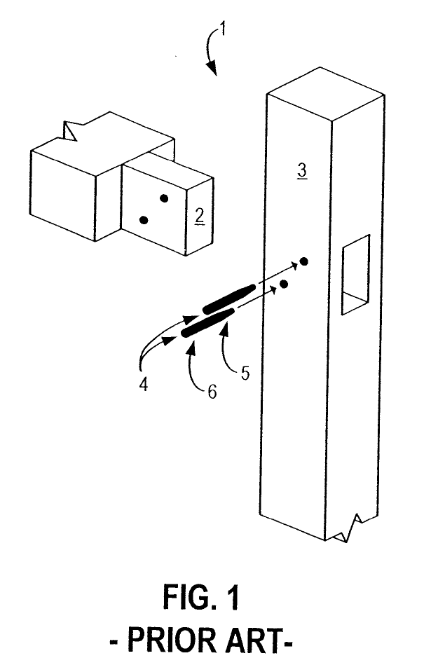

### DETAILED DESCRIPTION

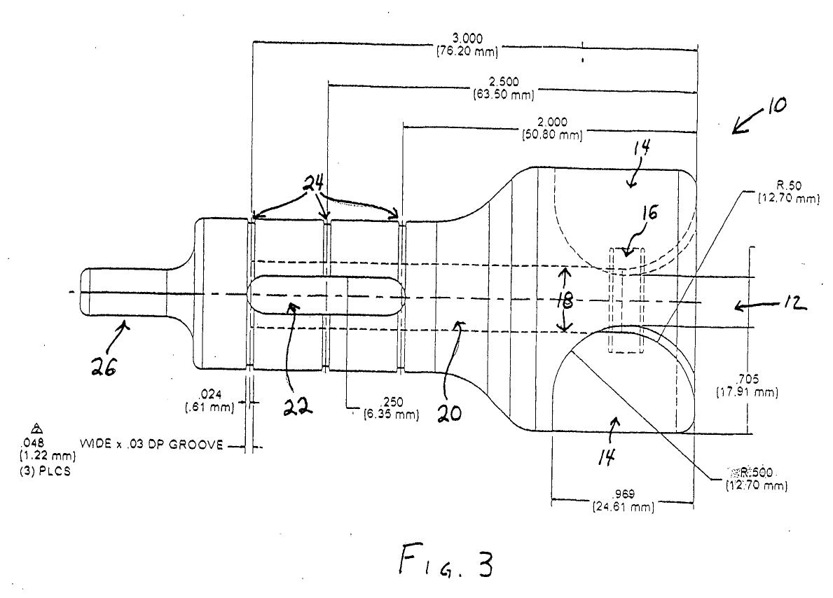

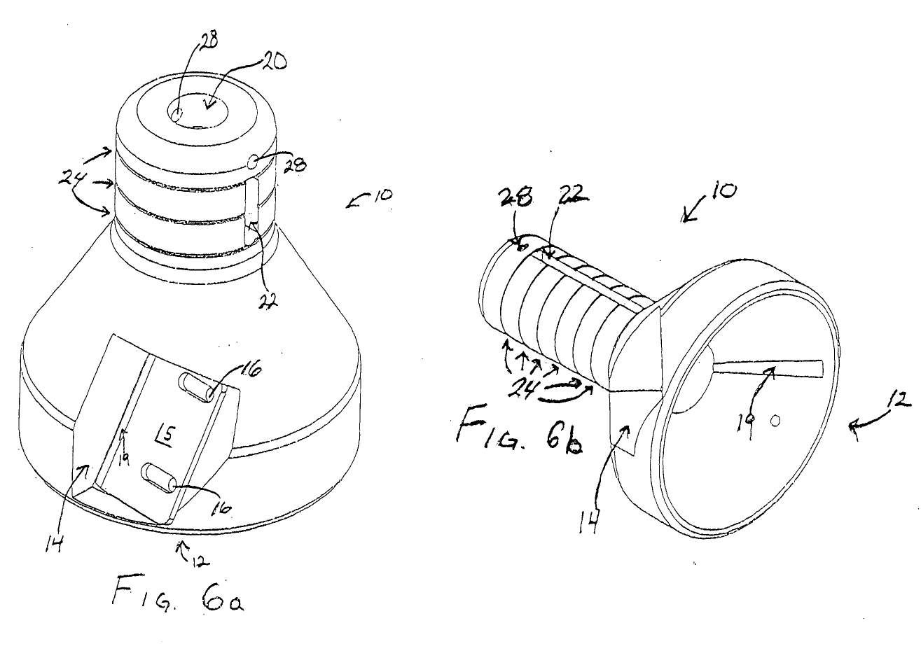

Referring generally to FIGS. 3-6b, a plurality of portable chamfer tools 10 in varying sizes and views is shown. For example, it is contemplated that the chamfer tool 10 may be constructed in sizes including ⅜ inch, ¾ inch, 1 inch, 1 and ½ inch, 2 inch, 3 inch, and the like or may include substantially larger or smaller sizes. Regardless of overall size, each portable chamfer tool 10 includes a cutting passage 12 around which a pair of cutting blade mounts 14 is disposed. It is contemplated that the chamfer tool 10 housing may be formed of a single machined piece of aluminum so that the chamfer tool 10 is structurally rugged and highly portable. It is contemplated that the chamfer tool 10 includes one and, preferably, two or more cutting blades that are reusable and replaceable. For example, a cutting blade 15 (FIG. 6a), for example a steel blade, can be disposed in the blade mount 14 and secured using a screw receptacle 16. As such, the blade 15 disposed in the cutting blade mount 14 extends into the cutting passage 12 to cut a portion of a workpiece passing through the cutting passage 12 to a diameter equal to a diameter 18 of the cutting passage 12. The blade mount 14 not only secures the blade 15 in the desired cutting position, it also provides a portal 19 to allow refuse cut from the workpiece to form the tenon or taper to escape the chamfer tool 10.

Extending from the cutting passage 12 is a tenon passage 20. A plurality of sights 22 formed as cutouts or slots is disposed about the tenon passage 20 to allow a user to identify the length of the tenon during cutting. Encircling the exterior of the tenon passage 20 is a plurality of index grooves or measuring markers 24. Extending from an end of the tenon passage 20 opposite the cutting passage 12 is a hexagonal peg 26 configured to be engaged by a traditional hand drill (not shown).

In operation, a workpiece requiring a taper or a tenon is fed into the cutting passage 12. As the workpiece enters the cutting passage 12, the cutting blades 15 disposed in the cutting blade mounts 14 engage the workpiece. Accordingly, the workpiece is cut to form a taper extending from the original workpiece diameter to a diameter equal to the diameter 18 of the cutting passage 12.

Once cut, the workpiece passes from the cutting passage 12 into the tenon passage 20. As the workpiece extends into the tenon passage 20 it passes into operator view through the sights 22. Accordingly, by viewing the workpiece as it passes into the tenon passage 20, an operator can quickly estimate the length of the tenon formed on the workpiece. In the embodiments illustrated in FIGS. 3-6b, the chamfer tool 10 includes two sights 22 disposed on opposite sides of the tenon passage 20. However, it is contemplated that the chamfer tool 10 may include at least four sights 22. That is, by including four or more sights 22 disposed evenly around the tenon passage 20, the length of the tenon extending through the tenon passage 20 is continuously visible to the operator as the chamfer tool 10 rotates.

To allow the operator to immediately and accurately identify the actual length of the tenon during the cutting process, the operator needs to simply compare the extent of the tenon passing through the sights 22 to the measuring markers 24. As shown, the measuring markers 24 are positioned along the exterior of the tenon passage 20 to form a point of reference to which an operator can compare the workpiece extending through the sights 22 to immediately and accurately identify the actual length of the tenon during the cutting process.

While the measuring markers 24 are shown as a plurality of grooves evenly spaced along and completely encircling the exterior of the tenon passage, numerous variations may be made while still achieving the desired functionality. For example, instead of grooves, the measuring markers 24 may be painted on the exterior of the tenon passage 20 or other non-etched marks may be formed on the exterior of the chamfer tool 10. Furthermore, while it is preferable that measuring markers 24 completely encircle at least the tenon passage 20 so that the measuring markers 24 are continuously visible as the chamfer tool 10 rotates, it is contemplated that the measuring markers 24 may be reduced to encircle less than the whole of the tenon passage 20 while still providing the desired functionality. Additionally, while the measuring markers 24 are shown as being evenly spaced, it is contemplated that the measuring markers 24 may be advantageously unevenly spaced for some applications. For example, it is contemplated that the measuring markers 24 may be disposed at reducing intervals extending from the cutting passage 12 to the hexagonal peg 26. In this regard, the measuring markers 24 present the operator with a measurement that is less accurate when the workpiece enters the tenon passage 20 but becomes more accurate as the workpiece moves through the tenon passage 20. Also, it is contemplated that the measuring markers 24 may be accompanied with etched or painted measurement values indicating the length of the tenon created when the workpiece extends to a given measuring marker 24.

Additionally, it is contemplated that taper shape created by the chamfer tool 10 may be varied by adjusting a shape of the chamfer tool 10 and the position of the blades when secured therein. For example, as shown in FIGS. 3-6b, the diameter of the cutting passage 12 and the tenon passage 20 may be varied. Similarly, the shape and mounting position of the cutting blades as well as the interface between the cutting passage 12 and the tenon passage 20 may be varied. In this regard, as shown FIGS. 3-5, a rounded cutting blade may be mounted in a rounded cutting blade mount 14 to create a rounded taper on the workpiece. On the other hand, as shown in FIGS. 6a and 6b, a flat blade 15 may be mounted in a flat blade mount 14 to create a planar angled taper on the workpiece. Accordingly, it is contemplated that the blade mount 14 may be configured to receive a wide variety of cutting blades such as rounded, straight, simple, or complex blades.

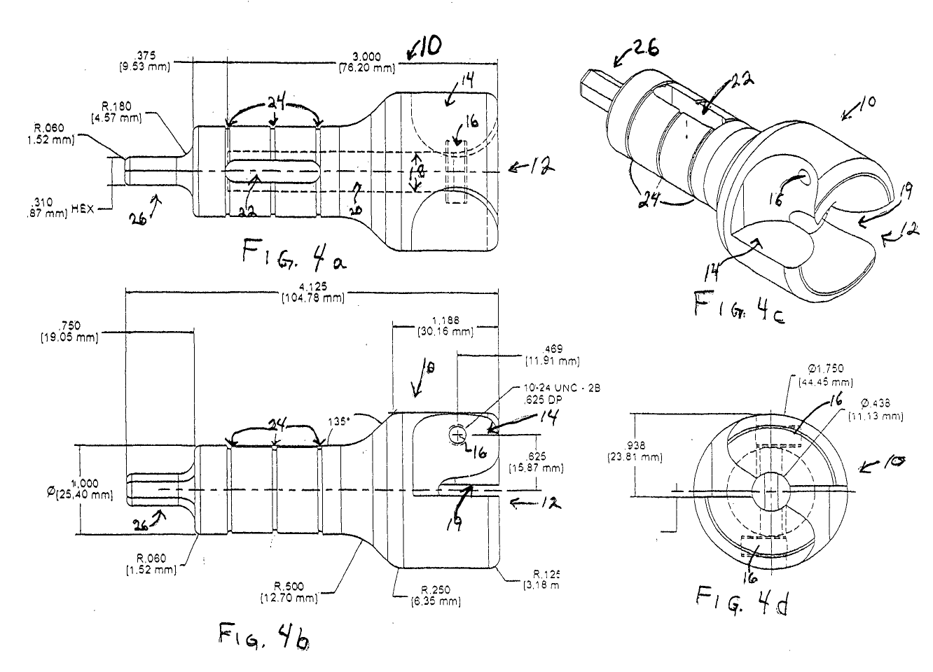

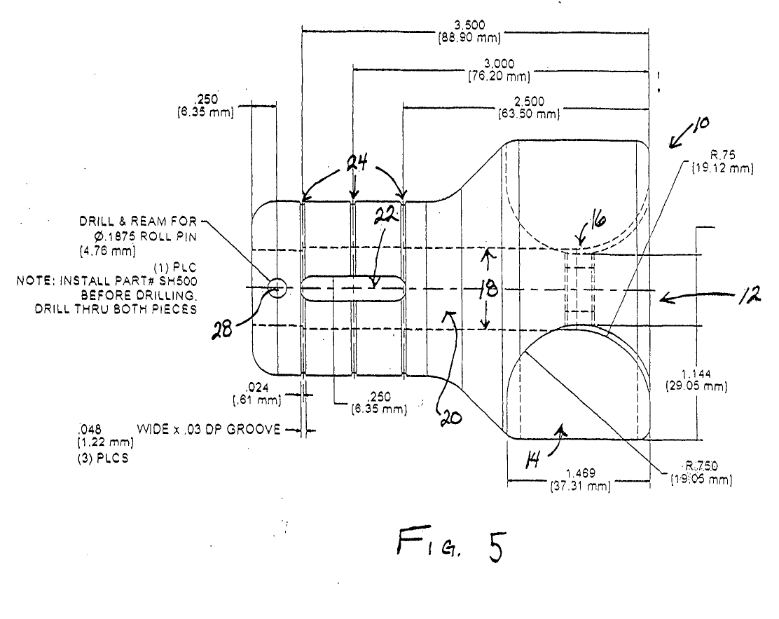

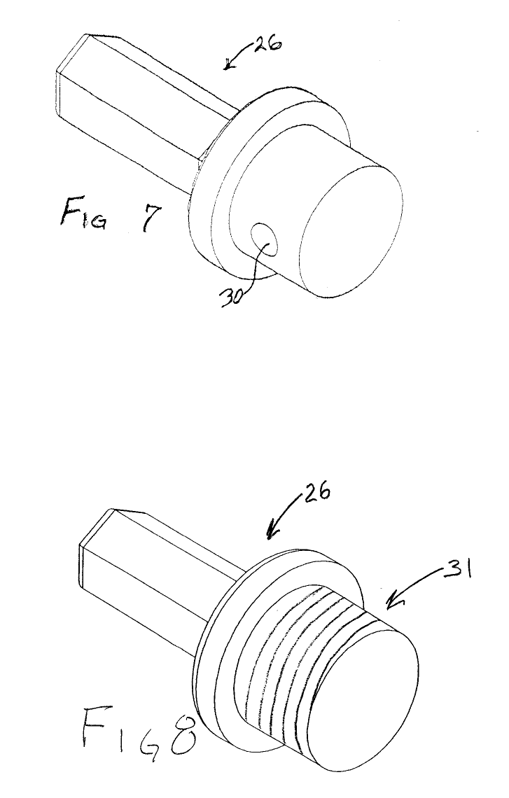

Furthermore, as shown in FIGS. 3-4d, the hexagonal peg 26 may be integrated into the chamfer tool 10. However, as shown in FIGS. 5-8, it is also contemplated the hexagonal peg 26 may be formed as an independent device that is configured to engage the chamfer tool 10. That is, as shown in FIGS. 5-6b and 7, the tenon passage 20 may extend through the end of the chamfer tool 10. In this regard, the hexagonal peg 26 can be positioned to form an end cap of the tenon passage 20 and be held in place by a roll pin extended through a pin shaft 28 in the chamfer tool 10 and corresponding pin shaft 30 in the hexagonal peg 26. Alternatively, referring to FIG. 8, it is contemplated that the hexagonal peg 26 may include a threading 31 that is configured to engage a reciprocal threading (not shown) formed in the chamfer tool 10.

Also, though the sights 22 are shown in FIGS. 3-6b as extending along the tenon passage 20 and terminating prior to the cutting passage 12, it is contemplated that the sights may be extended into the cutting passage 12 to enable a user to determine the length of a taper formed by the chamfer tool 10 prior to forming a tenon. In this regard, the measuring markers 24 may also be extended into the cutting passage 12.

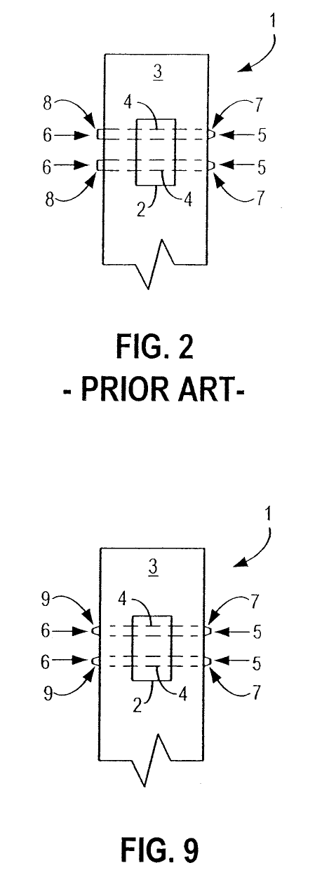

It is contemplated that the chamfer tool 10 may be used in a variety of applications. In particular, referring to FIG. 9, the portable chamfer tool described above with respect to FIGS. 3-8 can be used to create a second tapered end 9 that is matched to the preformed tapered end in an assembled mortise-and-tenon joint 1. That is, using the above-described chamfer tool, each builder of a timber home or building can quickly and easily match the blunt end 8 of the peg 4 with the preformed taper 7 profile created at the factory. Specifically, after assembling a traditional mortise-and-tenon joint (FIG. 2), a builder can engage the above-described chamfer tool in a cordless or electric drill to rotate the chamfer tool about the blunt end 8 of the peg 4, thereby forming a taper 9 easily matched to the preformed taper 7 because the builder can use the aforementioned measuring markers to determine when a taper matching the factory preformed taper 7 has been created without having to repeatedly remove the chamfer from the peg 4 to measure the taper.

The present invention has been described in terms of the preferred embodiment, and it should be appreciated that many equivalents, alternatives, variations, and modifications, aside from those expressly stated, are possible and within the scope of the invention. Therefore, the invention should not be limited to a particular described embodiment.

We claim:

1. A portable chamfer tool comprising:
a housing configured to support a blade to cut a tenon into a workpiece as the housing is rotated about the workpiece;
a passage through the housing configured to receive the workpiece and expose the workpiece to at least one blade to form the tenon;
at least one sighting hole disposed in the housing to expose a portion of the workpiece as it travels through the passage; and
at least one measuring marker around the housing and intersecting the at least one sighting hole to indicate a measure of a length of the portion of the workpiece exposed by the at least one sighting hole.

2. The portable chamfer tool of claim 1 wherein the at least one measuring marker includes a groove extending substantially around an exterior of the housing.

3. The portable chamfer tool of claim 1 wherein the at least one sighting hole includes four sighting holes disposed in the housing.

4. The portable chamfer tool of claim 3 wherein the four sighting holes are disposed at even intervals around the housing.

5. The portable chamfer tool of claim 1 further comprising at least one blade mount formed in the housing to mount the at least one blade in the housing.

6. The portable chamfer tool of claim 5 wherein the at least one blade mount is configured to secure a planar blade in a position to cut a substantially frusto-conical taper into the workpiece.

7. The portable chamfer tool of claim 5 wherein the at least one blade mount is configured to secure a rounded blade to cut a rounded taper into the workpiece.

8. The portable chamfer tool of claim 1 further comprising a portal formed in the housing to allow workpiece refuse to pass from the housing.

9. The portable chamfer tool of claim 1 further comprising a peg configured to be engaged by a drill to rotate the housing about the workpiece.

10. The portable chamfer tool of claim 1 wherein the workpiece is a blunt end of a peg passing through a tenon and mortise joint.

11. The portable chamfer tool of claim 10 wherein the tenon and mortise joint is part of a timber home.

12. A method of constructing a tenon and mortise joint, the method comprising the steps of:
positioning a precut tenon inside a precut mortise;
aligning at least one precut peg hole in the tenon with at least one precut peg hole in the mortise;
driving a first end of a peg having a preformed taper thereabout into the at least one precut peg hole in the tenon and the at least one precut peg hole in the mortise by striking a second end of the peg having a consistent diameter; and
once the peg is positioned through the at least one precut peg hole in the tenon and the at least one precut peg hole in the mortise, forming a taper on the second end of the peg using a portable chamfer tool.

13. The method of claim 12 wherein the taper formed on the second end of the peg is substantially matched to the preformed taper on the first end of the peg.

14. The method of claim 12 wherein the tenon and mortise joint is part of a timber home.

15. The method of claim 12 wherein the step of forming a taper further comprises measuring a length of the taper formed using at least one sight and corresponding measurement markers disposed about the portable chamfer tool.

16. A portable chamfer tool comprising:
a first end configured to receive a workpiece for creating a tenon therein;
a first portion configured to be rotated about the workpiece to cut the tenon from the workpiece;
a second portion configured to receive the tenon as it passes from the first portion and provide a metered indication of a length of the tenon as it is formed by the first portion.

17. The portable chamfer tool of claim 16 further comprising:
at least one sighting hole disposed in the second portion to expose the tenon as it travels through the second portion;
a plurality of measuring markers disposed about the at least one sighting hole; and
wherein the at least one sighting hole and the plurality of measuring markers provide the metered indication of the length of the tenon as it is formed.

18. The portable chamfer tool of claim 16 wherein the workpiece is a blunt end of a peg passing through a tenon and mortise joint.

19. The portable chamfer tool of claim 16 further comprising a peg configured to be engaged by a hand-held drill to rotate the first portion about the workpiece.

20. The portable chamfer tool of claim 19 wherein the peg is configured to be secured to the second portion through one of a pin and a threaded engagement.

21. The portable chamfer tool of claim 16 further comprising a blade mount disposed in the first portion to removably fix a blade in position to cut the tenon from the workpiece.

22. A method of measuring a length of at least one of a peg taper and a tenon, the method comprising the steps of:
positioning a workpiece proximate a chamfer;
feeding the workpiece into a passage in the chamfer to expose the workpiece to at least one blade of the chamfer;
viewing a portion of the workpiece cut by the at least one blade through at least one sighting slot disposed in the chamfer; and
comparing the portion of the workpiece viewed through the at least one sighting slot to at least one measuring marker to determine a length of the portion of the workpiece cut by the at least one blade.

23. The method of claim 21 wherein the step of comparing is performed simultaneously with the step of feeding.
